(19) United States
(12) Patent Application Publication
(10) Pub. No.: US 2004/0119740 A1
(43) Pub. Date: Jun. 24, 2004

(54) Methods and apparatus for displaying and replying to electronic messages

(75) Inventors: Bay-Wei Chang, Foster City, CA (US); Paul Buchheit, Mountain View, CA (US); Sanjeev Singh, South San Francisco, CA (US)

Correspondence Address: Valley Oak Law, 5655 Silver Creek Valley Road, #106, San Jose, CA, 95138, US

(73) Assignee: GOOGLE, INC., a Corporation of the State of California, Mountain View, CA

(21) Appl. No.: 10/328,821

(22) Filed: Dec. 24, 2002

(51) Int. Cl. G09G 5/00

(52) U.S. Cl. 345/751

(57) ABSTRACT

Methods and apparatus are described for viewing and responding to electronic messages. In one embodiment, when an electronic message is displayed, a portion of the electronic message is elided to aid in the viewing experience. In one embodiment, a method of viewing a first electronic message, comprises: identifying an extraneous portion within a second electronic message; eliding the extraneous portion within the second electronic message; and generating the first electronic message wherein the first electronic message includes the second electronic message with the extraneous portion of the second electronic message suppressed.

### FIELD OF THE INVENTION

The present invention relates generally to viewing messages and, more particularly, to viewing messages in a conversational view format.

### BACKGROUND OF THE INVENTION

Electronic messaging has become indispensable for exchanging information between a sender and recipient. With increasing access to the Internet, more people are utilizing electronic messaging to communicate with each other both for business and leisure. Compared to sending traditional mail, placing a phone call, or sending a facsimile, electronic messaging is gaining popularity because in part of the immediacy of transmission and ease of response. However, with increased popularity, reading and responding to numerous electronic messages is becoming increasingly time-consuming and burdensome.

There are many forms of electronic messaging such as bulletin board systems, messenger systems, and email systems. Bulletin board systems allow the members of the system to view electronic messages in a thread format. The members can post electronic messages as a new topic or can reply to a prior message and generate a reply message within an existing thread. Unfortunately, bulletin board systems do not allow designated recipients for electronic messaging on a message by message basis, which limits the privacy of this form of electronic messaging. Instead, bulletin board systems typically allow all members to view posted electronic messages. Additionally, members are typically required to use a proprietary user interface in order to utilize the bulletin board system. For example, the bulletin board owner typically provides the proprietary user interface for use with the bulletin board.

Messenger systems such as Yahoo Messenger™ and MSN Messenger™ allow participants to exchange electronic messages in a conversational style. These messenger systems also allow the sender of the electronic message to designate the recipient. However, the sender and the recipient are typically required to subscribe to the same messenger system. Additionally, the messenger systems typically require users to utilize a proprietary user interface in order to send and receive electronic messages.

Email systems allow participants to exchange electronic messages and designate recipients. Email messages can be exchanged between parties which utilize different email programs. Although web-based email providers such as MSN Hotmail™, and Yahoo™ typically require a user to utilize a proprietary user interface to send and receive email messages, other email systems allow users to select any email program to send and receive email messages. Email systems typically do not allow recipients to view electronic messages in a thread format. An email program may list email messages by grouping messages based on subject, so that related messages are grouped together. However, viewing email messages by subject lines is not a convenient way to read email messages.

It would be useful, therefore, to have methods and apparatus for displaying and replying to electronic messages in a more convenient manner.

### SUMMARY OF THE INVENTION

Methods and apparatus are described for viewing and responding to electronic messages. In one embodiment, when an electronic message is displayed, a portion of the electronic message is elided to aid in the viewing experience. In one embodiment, a method of viewing a first electronic message, comprises: identifying an extraneous portion within a second electronic message; eliding the extraneous portion within the second electronic message; and generating the first electronic message wherein the first electronic message includes the second electronic message with the extraneous portion of the second electronic message suppressed.

### BRIEF DESCRIPTION OF THE DRAWINGS

The accompanying drawings, which are incorporated in and constitute a part of this specification, illustrate one embodiment of the invention and, together with the description, explain one embodiment of the invention. In the drawings,

FIG. 1 is a diagram illustrating an environment within which the invention may be implemented;

FIG. 2 is a simplified block diagram illustrating an electronic messaging system consistent with one embodiment of the invention;

FIG. 3 is a simplified block diagram illustrating one embodiment in which the invention may be implemented;

FIG. 4 is a flow diagram for generating an electronic message, consistent with one embodiment of the invention;

FIG. 5 is a flow diagram for generating an electronic message, consistent with one embodiment of the invention;

FIG. 6 is a flow diagram for generating a plurality of electronic messages, consistent with one embodiment of the invention;

FIG. 7 is a screen shot illustrating a conversational view of a plurality of electronic messages, consistent with one embodiment of the invention;

FIG. 8 is a screen shot illustrating a summary view of a plurality of electronic messages, consistent with one embodiment of the invention; and

FIG. 9 is a screen shot illustrating a reply box, consistent with one embodiment of the invention.

### DETAILED DESCRIPTION

The following detailed description of the invention refers to the accompanying drawings. The detailed description does not limit the invention. Instead, the scope of the invention is defined by the appended claims and equivalents.

The present invention includes methods and apparatus for generating and displaying electronic messages. The present invention also includes methods and apparatus for replying to electronic messages. In one embodiment, a portion of the electronic message is selectively suppressed and is hidden from view. In one embodiment, the portion of the electronic message which is suppressed may include header information, signature information, and/or repeated text. In one embodiment, additional information may be included within the electronic message. This additional information may include the identity of the sender, a symbol representing the repeated text, and the like. In one embodiment, a reply box may be viewed simultaneously with the electronic message. In one embodiment, a plurality of electronic messages may be presented in a conversation view. In another embodiment, the plurality of electronic messages may be presented in a summary view.

Those skilled in the art will recognize that many other implementations are possible, consistent with the present invention.

A. Environment and Architecture

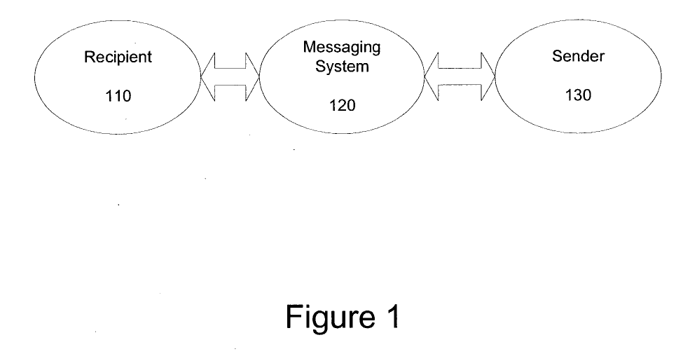

FIG. 1 is a diagram illustrating an environment within which the invention may be implemented. The environment includes a recipient 110, a messaging system 120, and a sender 130.

The recipient 110 may be the party that is targeted to receive a message. The message may be in a variety of forms ranging from email, community discussion sites, archived mailing lists, bulletin boards, or any other type of electronic messaging.

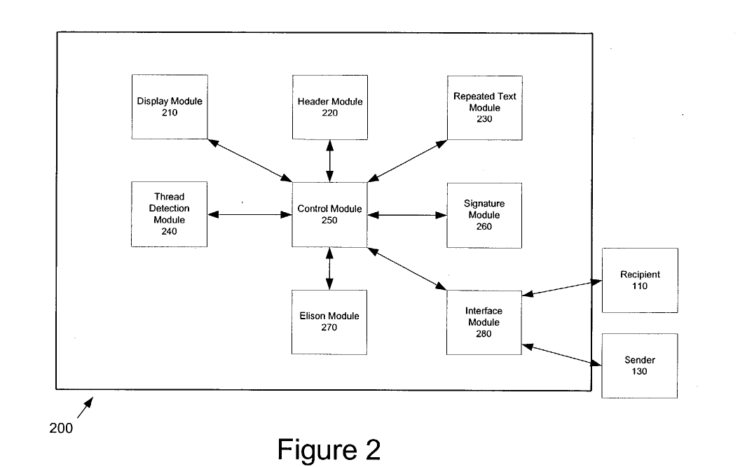

The messaging system 120 interfaces with both the recipient 110 and the sender 130. It performs a variety of functions, as explained in more detail below in reference to FIGS. 2 through 9.

The sender 130 is the party which sends the message to the recipient 110 through the messaging system 120.

FIG. 2 illustrates one embodiment of an electronic messaging system 200 consistent with the invention. The system 200 includes a display module 210, a header module 220, a repeated text module 230, a thread detection module 240, a control module 250, a signature module 260, an elision module 270, and an interface module 280. Use of the modules 210-280 within the system 100 are for exemplary purposes and are not intended to limit the scope of the invention. For the sake of simplicity and clarity, the electronic messaging system 200 is described in terms of email messages when references are made to electronic messages as an exemplary embodiment. In other embodiments, the electronic messaging system 200 may utilize community discussion sites, archived mailing lists, bulletin boards, or usenet groups as electronic messages.

In one embodiment, the electronic messaging system 200 is configured to selectively elide portions of an electronic message and display this shortened electronic message. The elided portions may include but are not limited to repeated text, redundant header information, signature information, and the like. In another embodiment, the electronic messaging system 200 may display a plurality of shortened electronic messages, thus forming a conversational view of multiple electronic messages. In one embodiment, the system 200 may display a plurality of electronic messages having portions of the message elided and an entire message elided, thus forming a summary view of multiple electronic messages.

In one embodiment, the control module 250 is coupled to the display module 210, the header module 220, the repeated text module 230, the thread detection module 240, the signature module 260, the elision module 270, and the interface module 280. In another embodiment, any of the modules 210-280 may be coupled with each other. In one embodiment, the control module 250 may be configured to coordinate requests and tasks between the display module 210, the header module 220, the repeated text module 230, the thread detection module 240, the signature module 260, the elision module 270, and the interface module 280.

The interface module 280 is configured to receive an electronic message from outside the system 200. The received electronic message may contain repeated text, header information, and/or signature information. The interface module 280 is also configured to transmit a displayed electronic message to a remote location outside the system 200. In one embodiment, the displayed electronic message represents the received electronic message. In one embodiment, the interface module 280 is configured to receive instructions from outside the system 200. In one embodiment, the interface module 280 is configured to display a user interface including a reply box.

The header module 220 is configured to detect header information which is contained within the received electronic message. In one embodiment, header information may include a unique identifier such as an email address; a time/date stamp; and/or a name of the sender.

The repeated text module 230 is configured to detect repeated information within the received electronic message. In one embodiment, the repeated information may include text within the received electronic message that is copied from a prior message. To detect the repeated information, the repeated text module 230 may search for a symbol which represents repeated text in one embodiment. This symbol may include the “>” character. In another embodiment, the repeated text module 230 may compare the text information within the received electronic message to the text information within a prior electronic message to determine whether repeated text exists within the received electronic message.

The thread detection module 240 is configured to categorize the received electronic message into an appropriate thread. For example, the received message may be part of a thread which relates to choosing a time among multiple people to play hockey. In other embodiments, various subjects may be discussed and comprise a thread.

The signature module 260 is configured to detect signature information that is contained within the received electronic message. The signature information may include a name of the sender; contact information of the sender; an inspirational quote; and/or other information which is appended to the received electronic message.

The elision module 270 is configured to selectively suppress a portion of the received electronic message. In one embodiment, the elision module 270 suppresses the repeated text, the header information, and/or the signature information in response to the repeated text module 230, the header module 220, and the signature module 260, respectively. In one embodiment, the elision module 270 selectively suppresses portion(s) of the received electronic message in response to the control module 250.

In one embodiment, the elision module 270 leaves the information within the original received electronic message intact and retrievable while suppressing portions of the original received electronic message. For example, the elision module 270 may suppress repeated text information within the received electronic message. However, this repeated text information within the received electronic message is still available for access.

The display module 210 is configured to format the received electronic message based on instructions from the control module 250. In one embodiment, the control module 250 instructs the display module 210 to generate the displayed electronic message. The displayed electronic message may include content of the received electronic message with selected portions elided in response to header module 220, the repeated text module 230, the signature module 260, and/or the elision module 270. In one embodiment, the display module 210 is configured to generate a plurality of displayed electronic messages which correspond to a plurality of received electronic messages.

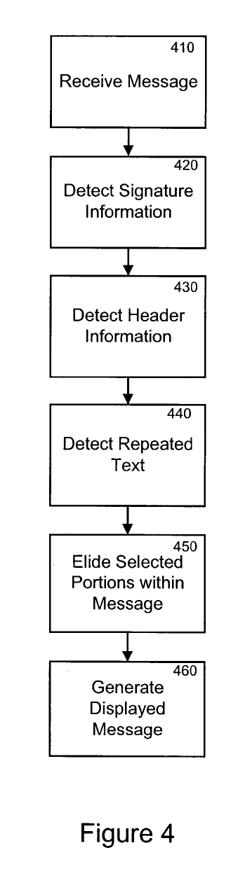

Exemplary embodiments which illustrate the operation of the system 200 are shown in subsequent flow diagrams contained in FIGS. 4, 5, and 6.

The modules 210-280 are merely illustrated in FIG. 2 as one embodiment of the system 200. Although the modules 210-280 are illustrated in FIG. 2 as separate modules of the system 200, two or more of these modules may be integrated, thus decreasing the number of modules in the system 200. Similarly, the modules 210-280 may also be separated, thus increasing the number of modules within the system 200. Additional modules may be added and modules may be deleted without departing from the scope of the invention. The modules 210-280 may be implemented in any combination of hardware, firmware and software.

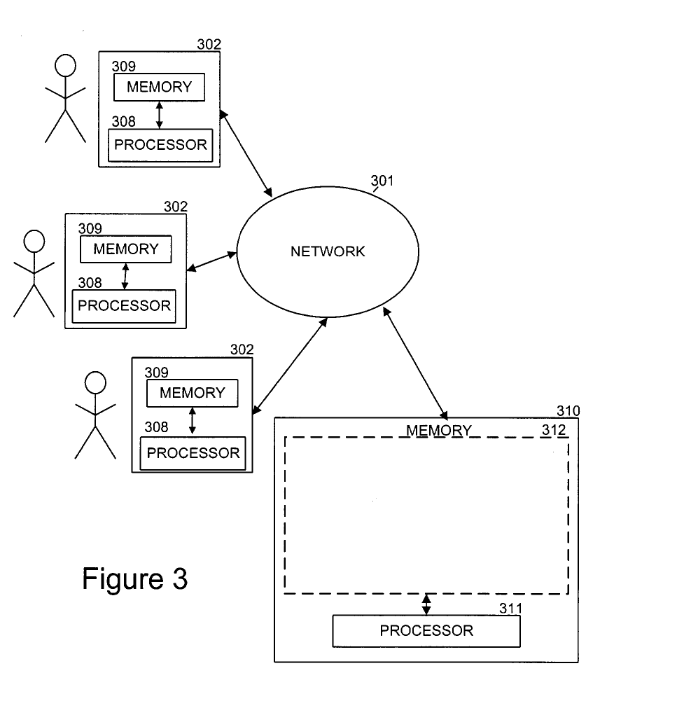

FIG. 3 is a simplified diagram illustrating an exemplary architecture in which the present invention may be implemented. The exemplary architecture includes a plurality of client devices 302, a server device 310, and a network 301. In one embodiment, the network 301 may be the Internet. The plurality of client devices 302 are each configured to include a computer-readable medium 309, such as random access memory, coupled to a processor 308. Processor 308 executes program instructions stored in the computer-readable medium 309. In another embodiment, the plurality of client devices 302 may also include a number of additional external or internal devices, such as, without limitation, a mouse, a CD-ROM, a keyboard, and a display.

Similar to the plurality of client devices 302, the server device 310 may include a processor 311 coupled to a computer-readable medium 312. The server device 310 may also include a number of additional external or internal devices, such as, without limitation, a secondary storage element, such as database 340.

The plurality of client processors 308 and the server processor 311 can be any of a number of well known computer processors, such as processors from Intel Corporation, of Santa Clara, Calif. In general, the plurality of client devices 302 may be any type of computing platform connected to a network and that interacts with application programs, such as a digital assistant or a “smart” cellular telephone or pager. The server 310, although depicted as a single computer system, may be implemented as a network of computer processors.

The plurality of client devices 302 and the server 310 may include the system 200 (FIG. 2). In one embodiment, the plurality of computer-readable medium 309 and 312 may contain, in part, the system 200. Additionally, the plurality of client devices 302 and the server 310 are configured to send and receive electronic messages for use with the system 200. Similarly, the network 301 is configured to transmit electronic messages for use with the system 200.

B. Operation

The flow diagrams as depicted in FIGS. 4, 5, and 6 are merely embodiments of the invention. In each embodiment, the flow diagrams illustrate the use of electronic messages within the system 200 (FIG. 2).

The blocks within the flow diagram may be performed in a different sequence without departing from the spirit of the invention. Further, blocks may be deleted, added, or combined without departing from the spirit of the invention.

The flow diagram in FIG. 4 illustrates one embodiment of generating a displayed electronic message in response to a received electronic message. In Block 410, the received electronic message is received. In one embodiment, the received electronic message may include header information, signature information, and/or repeated information.

In Block 420, signature information, if contained within the received electronic message, is detected. In one embodiment, the signature information may be detected by the signature module 260 (FIG. 2). In Block 430, header information within the received electronic message is detected. In one embodiment, the header information is detected by the header module 220 (FIG. 2). In Block 440, repeated text within the received electronic message is detected. There are multiple ways to detect repeated text. In one embodiment, the repeated text is detected by the repeated text module 230 (FIG. 2). The detection of header information, signature information and repeated text are shown for exemplary purposes. Additional portions of the received electronic message with different attributes may be detected.

In Block 450, selected portions of the received electronic message may be suppressed. In one embodiment, portions which are suppressed may include header information, signature information, and/or repeated text. The suppression of selected portions of the received electronic message may be performed by the elision module 270 (FIG. 2).

In Block 460, a displayed electronic message is generated. In one embodiment, the displayed electronic message is generated by the display module 210 (FIG. 2). In one embodiment, the displayed electronic message may selectively suppress portions of the received electronic message. These suppressed portions may include header information, signature information, and/or repeated text.

In another embodiment, a symbol may be inserted within the displayed message to represent repeated text which is suppressed. In one embodiment, the symbol may include a character. In another embodiment, the symbol may include a string of characters which summarizes the text which is suppressed.

In another embodiment, an abbreviated name be shown at the beginning of the displayed message may identify the identity of the sender in place of the complete header information within the received message. For example, a first name may be utilized to uniquely identify the sender of the received electronic message. However, a last name or other identifier of the sender may be utilized in the case of multiple parties having the same first name.

In one embodiment, generation of the displayed electronic message with a portion suppressed does not delete or alter the received electronic message. In another embodiment, although the suppressed portion of the displayed electronic message is not displayed, the suppressed portion is retained within the displayed electronic message. In both embodiments, the suppressed portion is viewable upon request.

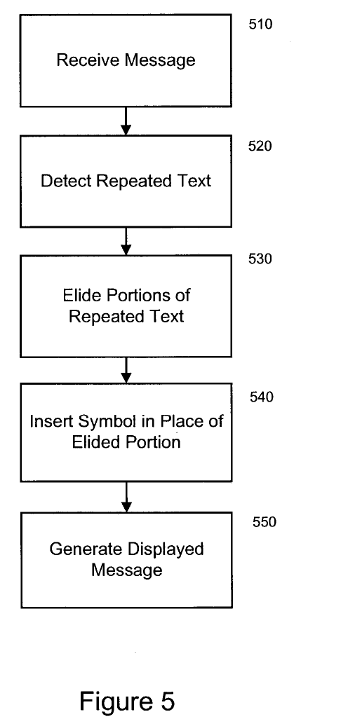

The flow diagram in FIG. 5 illustrates one embodiment of generating a displayed electronic message having portions of repeated text suppressed in response to a received electronic message. In Block 510, a received electronic message is received.

In Block 520, repeated text within the received electronic message is detected. Repeated text may be detected in multiple ways. In one embodiment, repeated text is detected in the repeated text module 230 (FIG. 2).

In Block 530, portions of the repeated text are suppressed in response to a location of new text within the received electronic message. In one embodiment, if the location of the new text is located within an area of the repeated text, then a portion of the repeated text is not suppressed. In one embodiment, a parameter may be utilized to determine the boundary of the portion of the repeated text that is not suppressed. For example, the repeated text that is not suppressed may be defined by repeated text within X characters of the new text (where X is defined by any integer.) This portion of repeated text that is not suppressed may be utilized to provide context to the new text that is contained within the received electronic message.

In one embodiment, when the new text is located outside the area of the repeated text, then the repeated text is suppressed.

In another embodiment, when the new text is located outside the area of the repeated text but the repeated text is needed to provide context for the new text, then portions of the repeated text are not suppressed.

In yet another embodiment, when the new text is located outside the area of the repeated text but the repeated text is located within Y characters of the new text (where Y is an arbitrary integer), then portions of the repeated text are not suppressed.

In one embodiment, the suppression of selected portions of the received electronic message may be performed by the elision module 270 (FIG. 2).

In Block 540, a symbol is inserted where repeated text is suppressed. The symbol is utilized to represent the suppressed text. In one embodiment, the symbol may be a character or a string of characters.

The string of characters may represent a summary of the suppressed text. In one embodiment, the summary may be a truncated version of the suppressed text. In another embodiment, the summary may selectively include portions of the suppressed text. For example, the suppressed text may include, “I am planning on playing hockey today if I complete my tasks at work.” In one embodiment, the string of characters representing the suppressed text may include “I am planning . . . ”. In another embodiment, the string of characters representing the suppressed text may include “I am . . . playing hockey today . . . ”

In Block 550, a displayed electronic message is generated. In one embodiment, the displayed electronic message is generated by the display module 210 (FIG. 2). In one embodiment, the displayed electronic message may selectively suppress portions of the repeated text within the received electronic message. Portions of the repeated text may be displayed within the displayed electronic message to provide context to the new text. Although the suppressed portions are not shown within the displayed electronic message, the suppressed portions may be available for viewing when requested. The suppressed portions may be represented by the symbol.

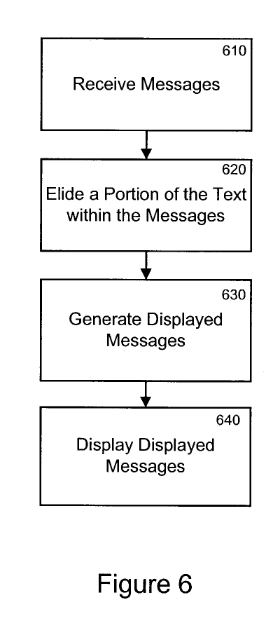

The flow diagram in FIG. 6 illustrates one embodiment of generating a plurality of displayed electronic messages having portions suppressed in response to a corresponding plurality of received electronic message. In Block 610, a plurality of received electronic messages is received. In Block 620, a portion within each of the plurality of received electronic messages are suppressed in one embodiment. In another embodiment, a portion within at least one of the plurality of received electronic messages is suppressed. In Block 630, the plurality of displayed electronic messages are generated in response to the suppressed portions of the plurality of received electronic messages.

In Block 640, the plurality of displayed electronic messages are displayed in a conversational view. In one embodiment, the conversational view includes simultaneously displaying multiple electronic messages while hiding the suppressed portions of the received electronic messages. In another embodiment, the conversational view includes simultaneously displaying multiple electronic messages while adding abbreviated sender information and hiding the header information, repeated text, and signature information. The abbreviated sender information may include a first name of the sender, a last name of the sender, a screen name of the sender, and/or a symbol representing the sender.

In another embodiment, the plurality of displayed electronic messages are displayed in a summary view. The summary view includes the suppression of at least one of the plurality of displayed electronic messages while being displayed.

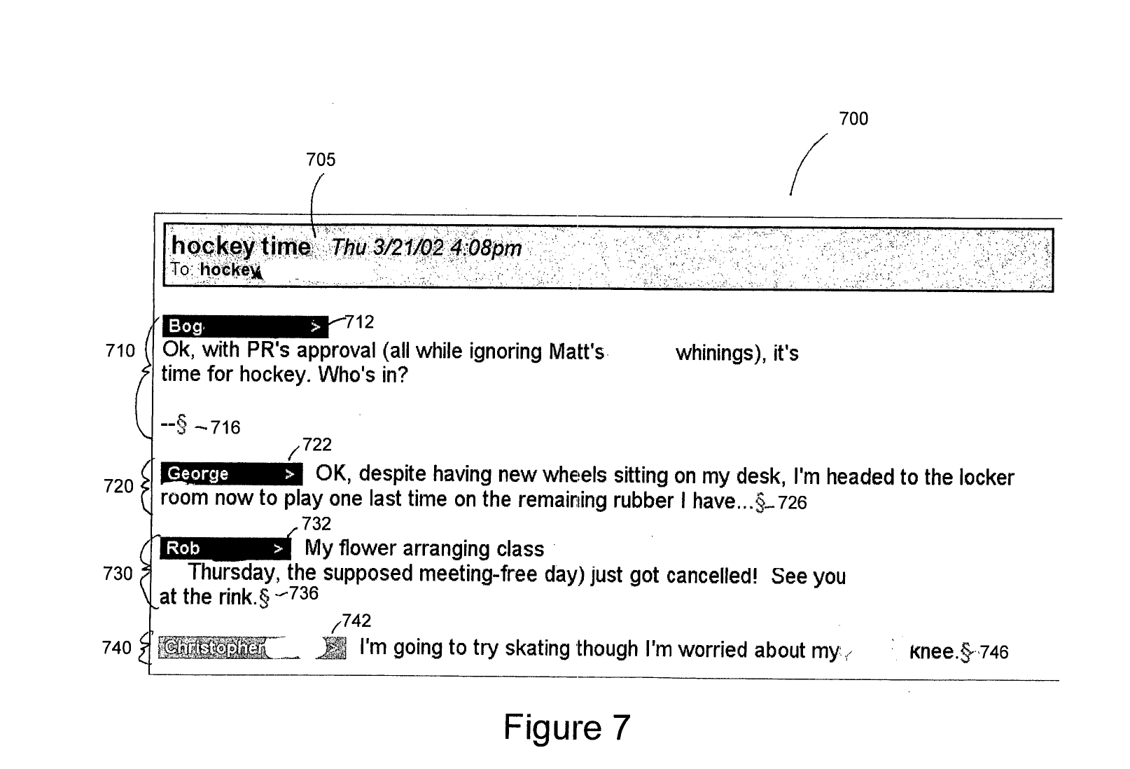

FIG. 7 shows a sample screen shot 700 illustrating a conversational view of a plurality of electronic messages according to one embodiment of the invention. The screen shot 700 displays a subject header 705 and a plurality of messages 710, 720, 730, and 740. In one embodiment, the subject header 705 displays information relating to the most current message 740. The plurality of messages 710, 720, 730, and 740 are shown with header information suppressed. In place of the full header information, the plurality of messages 710, 720, 730, and 740 are shown with the names of the senders 712, 722, 732, and 744, respectively.

Additionally, symbols 716, 726, 736, and 746 represent suppressed repeated text within the respective messages and are within the plurality of messages 710, 720, 730, and 740, respectively. In one embodiment, the repeated text is suppressed to aide in the conversational style in which the plurality of messages 710, 720, 730, and 740 are displayed. In another embodiment, the symbols 716, 726, 736, and 746 represent suppressed information. If the plurality of messages 710, 720, 730, and 740, contained signature information, the signature information is suppressed within the plurality of messages 710, 720, 730, and 740.

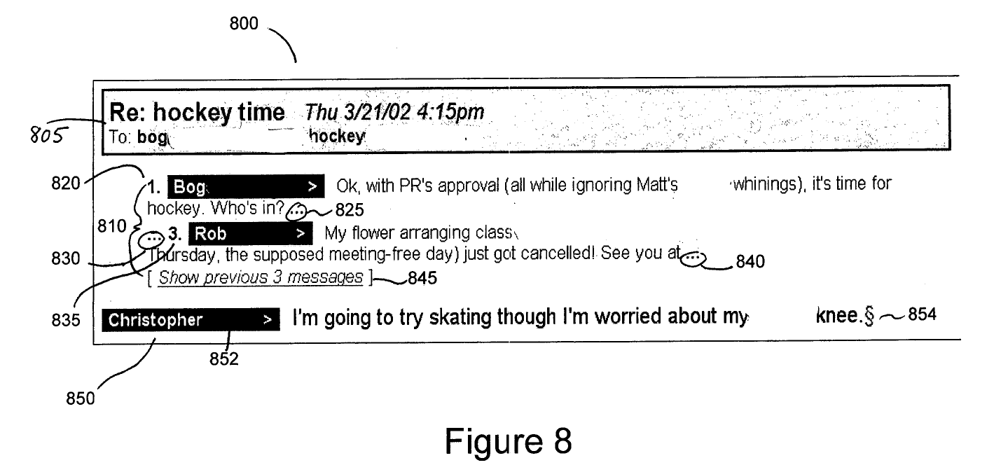

FIG. 8 shows a sample screen shot 800 illustrating a summary view of a plurality of electronic messages according to one embodiment of the invention. The screen shot 800 displays a subject header 805 and a plurality of messages 820, 835, and 850. In one embodiment, the subject header 805 displays information relating to the most current message 850.

Symbols 825 and 840 represent suppressed information within the messages 820 and 835, respectively. In one embodiment, the suppressed information is hidden in order to shorten the messages 820 and 835. The suppressed information is available for viewing in response to a request. A symbol 830 represents a suppressed message(s). The suppressed message(s) are available for viewing in response to a request and are hidden to allow a condensed viewing of the plurality of messages 820, 835, and 850.

Whether each particular message is displayed or elided is determined based upon various criteria. Some of the criteria include whether the message was previously read or viewed, whether the message has content which is relevant to a particular thread, and whether the message was manually selected.

An icon 845 is configured to receive a request to show additional messages which are currently not shown. The use of the icon 845 allows suppressed messages to be hidden while still being accessible for display upon request.

The message 850 is shown with header information suppressed. In place of the full header information, the message 850 is shown with the name of the sender 852. Additionally, symbol 854 represents suppressed repeated text within the message 850 and is shown within the message 850. In one embodiment, the repeated text is suppressed to aide in the conversational style in which the plurality of messages 820, 835 and 850 are displayed.

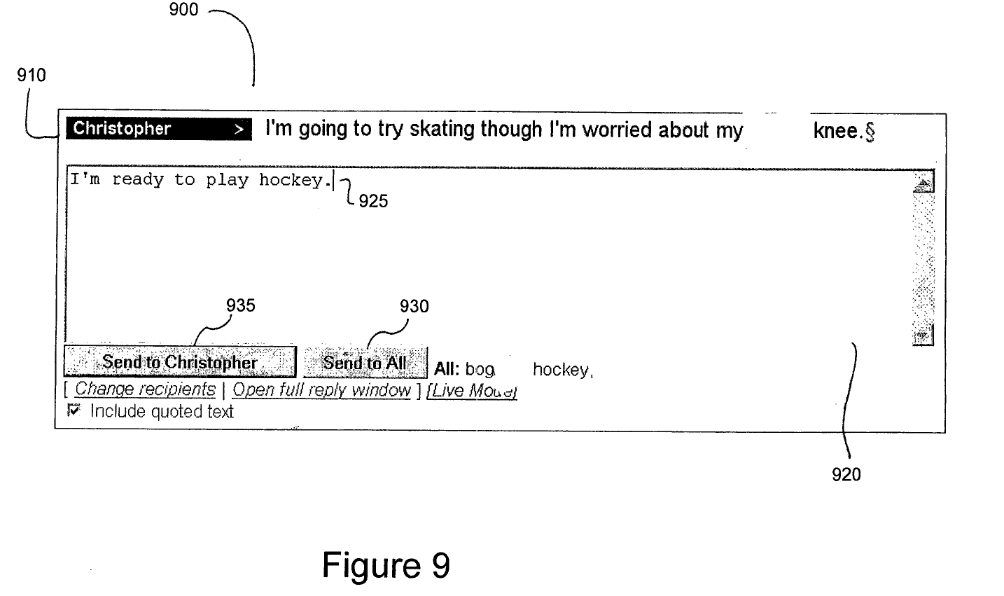

FIG. 9 shows a sample screen shot 900 illustrating a reply box for replying to a message according to one embodiment of the invention. The screen shot includes a message 910 and a reply box 920. In one embodiment, the message 910 is displayed in the conversational view (FIG. 7).

In one embodiment, the reply box 920 includes a text area 925 and icons 930 and 935. The text area 925 is configured to receive text input for the reply message. The icon 930 allows a user to send the reply message to all recipients within the thread. The icon 935 allows a user to send the reply message to only the sender of the message 910.

In the screen shot 900, the reply box 920 is positioned to be simultaneously viewed with the message 910. In one embodiment, the reply box 920 is configured to allow a sender to reply to the message 910 while still viewing the message 910 in the conversational view.

In one embodiment, the reply box 920 is selectively displayed based on a request to reply to a message. In one example, a reply to the message 910 is requested, and the reply box 920 is positioned adjacent to the message 910. The location of the reply box 920 adjacent to the message 910 in part facilitates a convenient manner to reply to the message 910, because the message 910 is viewable while utilizing the reply box 920.

In another embodiment, multiple messages are simultaneously displayed similar to those shown in FIGS. 7 and 8. In one embodiment, when a reply to a particular message is requested, the reply box 920 is positioned adjacent to the particular message to facilitate an easy reply. The actual position of the reply box 920 relative to the screen shot depends on the location of the particular message. In one embodiment, the reply box 920 may cover other messages besides the message being replied to.

In an alternate embodiment, the reply box 920 is positioned in the same location relative to the screen shot regardless of which message is chosen for a reply. In this alternate embodiment, the consistent location of the reply box 920 relative to the screen shot allows the user to predict the location of the reply box 920 regardless of the message chosen for a reply.

C. Conclusion

For the sake of clarity, the foregoing references to “icons” also includes buttons, links, and equivalents for describing graphics and/or words that represent functional attributes.

The terms “eliding, suppressing, and hiding” are utilized interchangeably to denote operations on portions of electronic messages which prevent them from being displayed for a given moment in time. The terms “eliding, suppressing, and hiding” are not to be construed as being synonymous with deleting.

The foregoing descriptions of specific embodiments of the invention have been presented for purposes of illustration and description. For example, the invention is described within the context of email messages as merely one embodiment of the invention. The invention may be applied to a variety of other electronic messages such as community discussion sites, archived mailing lists, bulletin boards, usenet groups, and the like.

They are not intended to be exhaustive or to limit the invention to the precise embodiments disclosed, and naturally many modifications and variations are possible in light of the above teaching. The embodiments were chosen and described in order to explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed:

1. A method of viewing a first electronic message, comprising:
identifying an extraneous portion within a second electronic message;
eliding the extraneous portion from the second electronic message; and
generating the first electronic message wherein the first electronic message includes the second electronic message with the extraneous portion of the second electronic message suppressed.

2. The method according to claim 1 further comprising displaying the first electronic message.

3. The method according to claim 2 further comprising selectively displaying the extraneous portion when displaying the first electronic message.

4. The method according to claim 1 further comprising receiving the second electronic message within a thread.

5. The method according to claim 1 wherein the second electronic message is an email.

6. The method according to claim 1 wherein the second electronic message is a usenet group message.

7. The method according to claim 1 wherein the second electronic message is a message within a bulletin board.

8. The method according to claim 1 wherein the extraneous portion is repeated text.

9. The method according to claim 1 wherein the extraneous portion is header information.

10. The method according to claim 1 wherein the extraneous portion is signature information.

11. The method according to claim 1 further comprising generating an indicia for inclusion within the first electronic message.

12. The method according to claim 11 wherein the indicia represents repeated text.

13. The method according to claim 11 wherein the indicia indicates an identity of a sender of the second electronic message.

14. The method according to claim 13 wherein the indicia is a first name of the sender.

15. The method according to claim 13 wherein the indicia is a last name of the sender.

16. The method according to claim 1 further comprising detecting a location of new text relative to a location of repeated text.

17. The method according to claim 16 further comprising selectively retaining portions of the repeated text within the first electronic message in response to detecting the location of the new text relative to the location of the repeated text.

18. A computer-readable medium having computer executable instructions for performing a method comprising:
identifying an extraneous portion within a second electronic message;
eliding the extraneous portion from the second electronic message; and
generating the first electronic message wherein the first electronic message includes the second electronic message with the extraneous portion of the second electronic message suppressed.

19. A messaging system for viewing a first electronic message, comprising:
means for identifying an extraneous portion within a second electronic message;
means for eliding the extraneous portion from the second electronic message; and
means for generating the first electronic message wherein the first electronic message includes the second electronic message with the extraneous portion of the second electronic message suppressed

20. A method of viewing a plurality of displayed messages in a conversational view, comprising:
identifying an extraneous portion within at least one of a plurality of received messages;
eliding the extraneous portion from at least one of the plurality of received messages; and
displaying the plurality of displayed messages in the conversational view wherein the plurality of displayed messages includes the plurality of received messages with the extraneous portion from at least one of the plurality of received messages suppressed.

21. The method according to claim 20 wherein the plurality of received messages comprise a thread.

22. The method according to claim 20 wherein the extraneous portion is repeated text.

23. The method according to claim 20 wherein the extraneous portion is header information.

24. The method according to claim 20 wherein the extraneous portion is signature information.

25. A computer-readable medium having computer executable instructions for performing a method comprising:
identifying an extraneous portion within at least one of a plurality of received messages;
eliding the extraneous portion from at least one of the plurality of received messages; and
displaying the plurality of displayed messages in the conversational view wherein the plurality of displayed messages includes the plurality of received messages with the extraneous portion from at least one of the plurality of received messages suppressed.

26. A system for viewing a plurality of displayed messages in a conversational view, comprising:
means for identifying an extraneous portion within at least one of a plurality of received messages;
means for eliding the extraneous portion from at least one of the plurality of received messages; and
means for displaying the plurality of displayed messages in the conversational view wherein the plurality of displayed messages includes the plurality of received messages with the extraneous portion from at least one of the plurality of received messages suppressed.

27. A method of replying to a displayed message, comprising:
eliding a portion of a received message;
forming the displayed message wherein the displayed message includes the received message with the portion suppressed;
selecting the displayed message for a reply; and
displaying a reply box in response to selecting the displayed message.

28. The method according to claim 27 further comprising locating the reply box adjacent to the displayed message.

29. The method according to claim 27 further comprising simultaneously displaying the displayed message while displaying the reply box.

30. The method according to claim 27 wherein the reply box further includes a text box.

31. The method according to claim 27 wherein the reply box further includes an icon for selecting a recipient for the reply.

32. The method according to claim 27 wherein the portion is repeated text.

33. The method according to claim 27 wherein the portion is header information.

34. The method according to claim 28 wherein the portion is signature information.

35. A computer-readable medium having computer executable instructions for performing a method comprising:
eliding a portion of a received message;
forming the displayed message wherein the displayed message includes the received message with the portion suppressed;
selecting the displayed message for a reply; and
displaying a reply box in response to selecting the displayed message.

36. A system for replying to a displayed message, comprising:
means for eliding a portion of a received message;
means for forming the displayed message wherein the displayed message includes the received message with the portion suppressed;
means for selecting the displayed message for a reply; and
means for displaying a reply box in response to selecting the displayed message.

37. A method of viewing a plurality of displayed messages in a summary view, comprising:
identifying a portion from at least one of a plurality of received messages;
eliding a portion from at least one of the plurality of received messages;
eliding at least one of the plurality of received messages; and
displaying the plurality of displayed messages in the summary view wherein the plurality of displayed messages includes the plurality of received messages with the portion from at least one of the plurality of received messages and at least one of the plurality of received messages suppressed.

38. The method according to claim 37 further comprising displaying a first indicia to represent the portion from at least one of the plurality of received messages.

39. The method according to claim 37 further comprising displaying a second indicia to represent the plurality of received messages elided from the plurality of displayed messages.

40. The method according to claim 37 wherein the portion is repeated text.

41. The method according to claim 37 wherein the portion is header information.

42. The method according to claim 37 wherein the portion is signature information.

43. The method according to claim 37 wherein eliding at least one of the plurality of messages is based on one of a particular message being already read, being relevant with context, and being manually selected.

44. A message system comprising:
a control module;
a detection module coupled to the control module for identifying an extraneous portion of a received message; and
an elision module coupled to the control module for suppressing the extraneous portion of the received message.

45. The system according to claim 44 further comprising a display module coupled to the control module for generating a displayed message, wherein the displayed message is the received message without the extraneous portion.

46. The system according to claim 44 further comprising an interface module for receiving the received message.

47. The system according to claim 44 wherein the detection module is configured to identify repeated text.

48. The system according to claim 44 wherein the detection module is configured to identify header information.

49. The system according to claim 44 wherein the detection module is configured to identify signature information.

50. The method according to claim 44 wherein the extraneous portion is repeated text.

51. The method according to claim 44 wherein the extraneous portion is header information.

52. The method according to claim 44 wherein the extraneous portion is signature information.
